(19) United States
(12) Patent Application Publication
(10) Pub. No.: US 2004/0142128 A1
(43) Pub. Date: Jul. 22, 2004

(54) Preform having anti-locking feature and mold for same

(76) Inventors: Dmitriy Shmagin, Itasca, IL (US); Emanuel Shenkar, Worth, IL (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/347,059

(22) Filed: Jan. 17, 2003

(51) Int. Cl. B29C 49/48; B65D 1/00

(52) U.S. Cl. 428/35.7; 425/470; 425/533

(57) ABSTRACT

A preform includes a tapered surface having projections formed thereon for contacting an adjacent, nested preform. The projections facilitate removal of a preform that has been inserted into an adjacent preform during shipping or handling prior to the reheat stage. A mold for forming the preforms all includes the projections.

### BACKGROUND

The invention relates to plastic articles and machinery for making the same, and more particularly to plastic preforms having features to inhibit or prevent locking of nested preforms or to diminish the force required to separate nested preforms.

Plastic containers are often formed in a two stage process. The first stage encompasses injection molding a preform into a predetermined shape. The second stage encompasses reheating the preform, inserting the preform in a mold, and blowing the preform against the mold walls to form a desired container shape. Often, the finish of the container is formed in the injection molding stage. However, the threaded area of the finish may be formed by blow molding for large mouth containers.

Between the injection molding stage and the reheat stage, preforms are often handled and shipped loose. During handling or shipping, nesting of one preform into an adjacent preform sometimes occurs. In this regard, FIG. 1 shows a preform 110 nested into an adjacent preform 110′, the latter of which is shown in cross section for clarity.

Preform 110 includes an open end portion 112, a transition portion 114, and a body 116. Open end portion 112 is shown in FIG. 1 having an injection molded finish, although the nesting phenomena is not limited to such preforms. An opening 120 is formed at open end portion 112, and body 116 terminates in an enclosed end 118. For preforms having a particular relationship between the outside diameter of body portion 116 near enclosed end 118 and an inside diameter of opening 120, enclosed end 118 is insertable into opening 120′ of an adjacent perform 110′, thereby enabling the nesting shown in FIG. 1.

Once a first preform 110 nests into adjacent preform 110′, the combination of performs 110 and 110′ may travel together, which enhances the ability of a third preform to nest in the combination. Further nesting sometimes produces long combinations or chains of preforms.

Un-scrambling equipment, which may be employed prior to the reheat process to orient and position the preforms, often includes a wheel-like device intended to separate nested preforms. However, such devices are not always effective, which may cause the preform feeding equipment to jam, thereby interrupting the preform feeding process. Long combinations of nested preforms or tightly nested preforms exacerbate separation problems of nested preforms. Heat and humidity conditions either at the un-scrambling stage or during shipping may exacerbate un-scrambling problems.

Because of the high production rate of commercial blow molding machines, which is typically several thousand per hour, even a short interruption in the feeding process may result in the interruption in the entire manufacturing process.

U.S. Pat. Nos. 5,366,774 and 5,756,172 disclose preforms having features to prevent nesting. The anti-nesting feature of the '774 patent is axially extending ribs disposed near the opening thereof. The ribs project toward the longitudinal centerline of the preform. Unfortunately, some spindles and blowing nozzles that enter into the preform throat during air injection of the blow molding process are configured to be inserted into a preform throat having a circular cross sectional surface, and the protruding ribs disclosed in the '774 patent may interfere with spindle insertion or performance. As each typical blow molding machine has hundreds of spindles, replacing the spindles would require significant cost and downtime, as well as possibly significant redesign costs. Further, the effectively reduced diameter may interfere with filling equipment, which also often is inserted into the throat.

The '172 patent also discloses features formed on the preform that prevent nesting. The anti-nesting features are protrusions formed on the exterior surface of the preform near its enclosed end. The protrusions act as obstacles to the insertion of the narrow end of the preform into the open end of an adjacent preform. Because the protrusions are on the outside of the perform, they may be subject to fracture during shipping and handling, thereby producing loose plastic bits. The loose plastic bits may fall into the preforms and remain in a blown bottle as a contaminant. Further, the protrusions may add difficulty to the manufacturing process and, under particular conditions (such a local cold spot on a mold surface and insufficient heating of the protrusion area of the preform), the protrusions may not fully disappear upon blow molding.

There is a need for improved features to alleviate drawbacks relating to nesting.

### SUMMARY

The inventors have discovered a relationship between the contact surface areas of nested preforms. As illustrated in FIG. 2, an outer surface 104 of prior art perform 110 may contact an inner surface 122′ of adjacent prior art preform 110′ in a line contact, in longitudinal cross section, as indicated by reference numeral 104. Even if the design geometry of preforms 110 and 110′ would provide for contact between the surfaces at merely one circumferential line (that is, at a point when viewed in cross section), preform surfaces 104 and 122′ may deflect to form a line contact, in longitudinal cross section, between points 105a and 105b. Such line contact may contribute to the difficulty in separating preforms 110 and 110′. The present invention is not, however, limited to circumstances in which such line contact of locking occurs (unless specifically recited in the claims), but rather encompasses any preforms in which nesting may occur.

A preform is provided that inhibits locking of one preform nested in another or that diminishes the force required to separate nested preforms. In this regard, the projections may prevent locking (that is, sticking or adhering) of a preform that is inserted into the throat of an adjacent preform, may provide for point contact that inhibits or prevent such locking, or that facilitates separation upon locking by conventional separation equipment prior to the reheating stage. The projections may be formed anywhere in the preform such that the projections do not form an undercut that would interfere with removal of the preform from the mold, and preferably are formed in the preform transition area.

For example, a preform for forming a blow-molded container may include a body internal diameter that is smaller than its throat internal diameter. An internal surface of a transition portion between the body and throat yields to the throat internal diameter at an upper end and to the body diameter at an opposing lower end thereof. Plural projections that are disposed on the transition internal surface extend inwardly therefrom. The projections are spaced apart from the throat opening such the projections are configured to contact an adjacent preform prior to blow molding (such as during handling) to diminish the force required to separate the preform from the adjacent preform upon nesting thereof.

The projections may substantially form point contact with a body external surface of the adjacent or nested preform. The projections may be limited to the transition surface such that the throat lacks projections. In some configurations, the projections are disposed entirely below a circumferential support ring formed on the throat. The projections, in front elevation view, preferably form a substantially downwardly tapered, rounded shape or other suitable geometry. The projections preferably do not form an undercut.

Further, an injection mold for forming a preform is provided. The injection mold defines a cavity comprising a throat and a tapered surface disposed on inside the preform and extending downwardly from the throat. The preform comprises plural projections disposed on the tapered surface. The projections are spaced apart from the throat opening such that the projections are configured to contact an adjacent preform during handling to diminish the force required to separate the preform from the adjacent preform upon nesting thereof.

### BRIEF DESCRIPTION OF THE FIGURES

FIG. 1 illustrates nesting of conventional preforms;

FIG. 2 is an enlarged view of a portion of conventional nested preforms;

FIG. 3 is a perspective view of a preform illustrating an embodiment of the present invention;

FIG. 4 is a side view of the preform shown in FIG. 3;

FIG. 5 is an end view of the preform shown in FIG. 3 taken along lines 5-5;

FIG. 6 is an enlarged, cross sectional view of the preform shown in FIG. 3 with another preform nested therein; and

FIG. 7 is an enlarged view of a portion of that shown in FIG. 6.

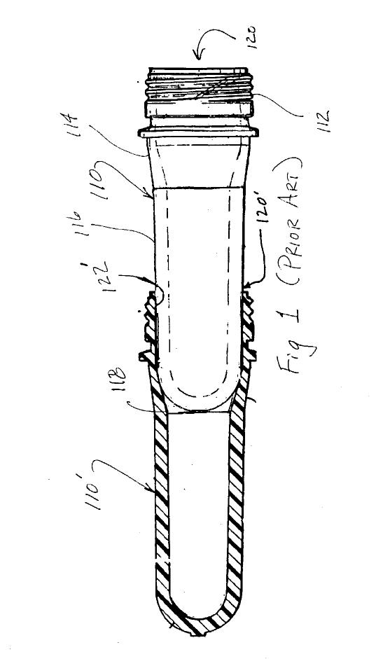

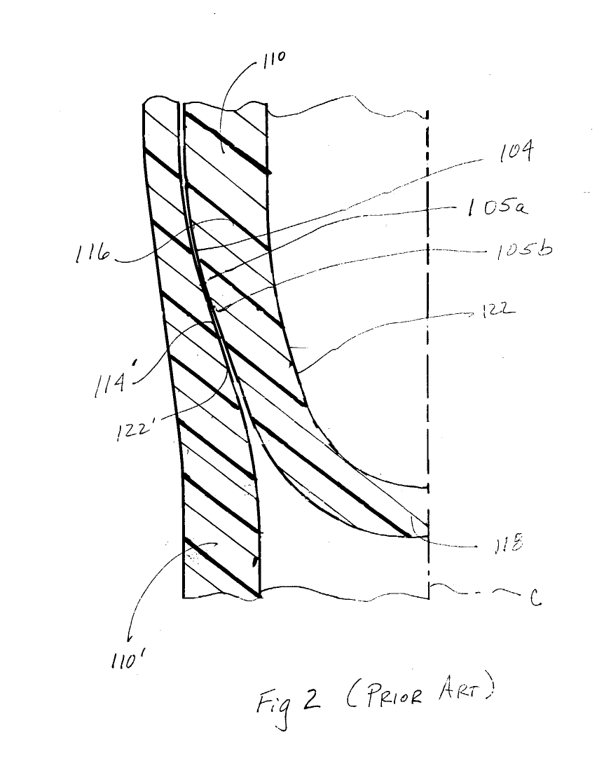

### DESCRIPTION OF PREFERRED EMBODIMENTS

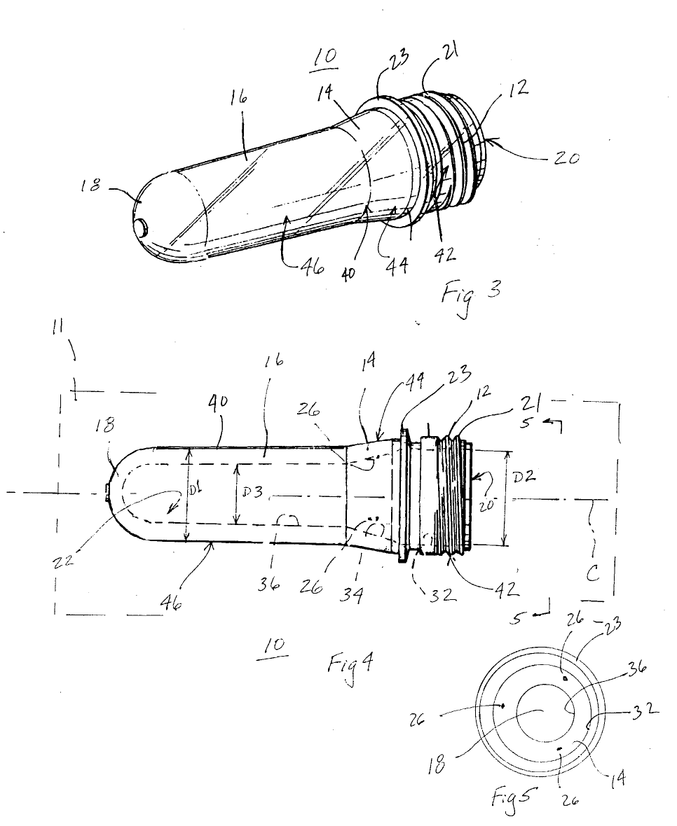

As best shown in FIGS. 3 and 4, a preform 10 includes a throat 12, a transition portion 14, and a body 18. Throat 12 is illustrated in FIGS. 3 and 4 having a finish 21, even though the present invention encompasses preforms that lack a finish, such as preforms adapted for forming wide mouth container in which the thread portion is blown, as will be understood by persons familiar with such wide mouth forming processes in view of the present disclosure. Throat 12 forms a throat opening 20 formed therein. A circumferential support ring 23 is formed on an exterior surface of throat 20 below finish 21.

Throat 12 yields to transition 14, which yields to body 16. Body 16 is generally cylindrical, even though the present invention is not limited to employing any particular geometry of the body. Body 16 terminates in an enclosed end 18. Preform 10 has an interior surface 22 and an external surface 40. Internal surface 22 includes a throat internal surface 32, a transition internal surface 34, and a body internal surface 36. In general, throat internal surface couples to transition internal surface, which couples to body internal surface. The term “couple” when used herein to describe relationships of corresponding surfaces, encompasses having another surface disposed between the surfaces that are the objects of the term. Further, the present invention encompasses radiused portions or other transitions between coupled surfaces.

External surface 40 includes a throat external surface 42, a transition external surface 44, and a body external surface 46. Body external surface defines a diameter D1, throat opening 20 defines an opening diameter D2, and body internal surface defines a body internal diameter D3. In a most preferred embodiment, and as shown in the figures, body internal diameter D3 is less than throat opening diameter D2 such that transition internal surface 34 makes the transition therebetween.

Throat 20 preferably has a smooth bore such that throat inner surface 32 without protrusions. Throat internal surface 32 and the upper portion of body internal surface 36 are illustrated as defining substantially tight circular cylinders. The present invention is not limited to such configurations, but rather encompasses any geometric or irregular shape. Further, transition internal surface 34 is illustrated as having a substantially frusto-conical shape, although the present invention encompasses any shape, including a curved shape (in longitudinal cross section), steps, irregularities, and the like, as will be understood to persons familiar with preform and blow molding technology considering the present disclosure.

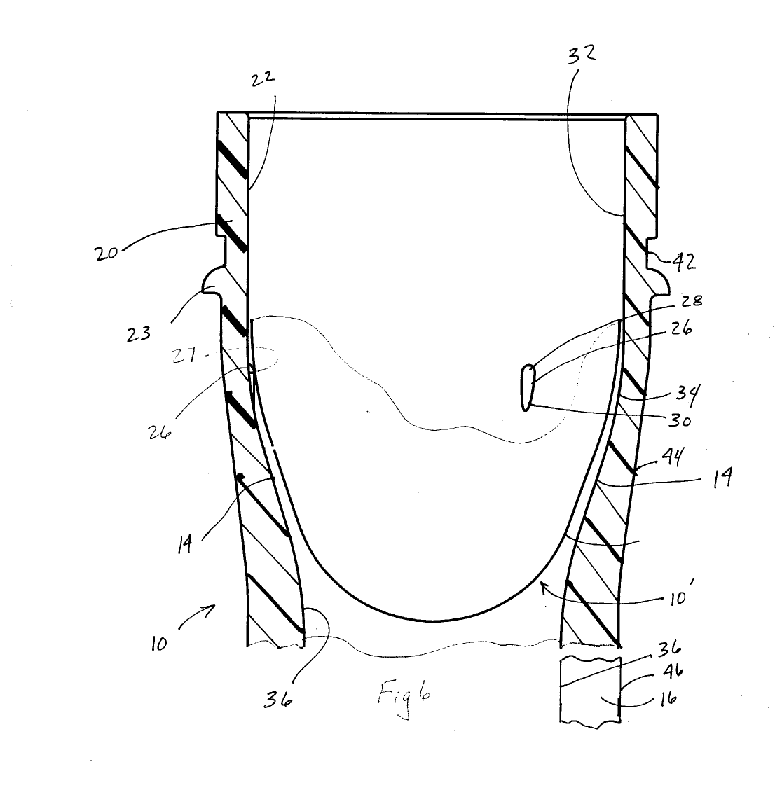

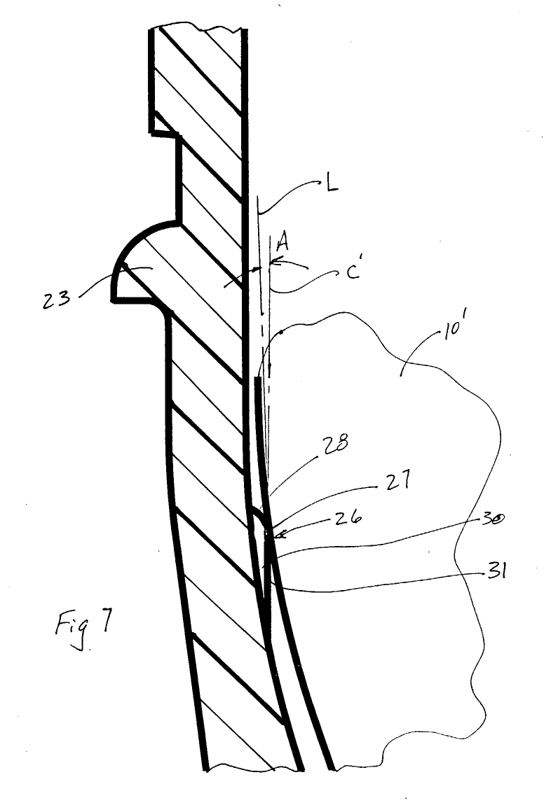

Plural projections, such as elongate embosses 26, are disposed on transition internal surface 34. Preferably, as best illustrated in FIG. 5, three projections 26 are disposed circumferentially equidistant apart. As best shown in FIGS. 6 and 7, each projection preferably forms a point contact 27 with an adjacent preform 10′ that is insertable into throat 12. Each projection 26 includes an upper rounded surface, such as half a hemisphere 28, and a downwardly extending longitudinal tail or lower portion 30.

As best shown in FIG. 7, projection 26 in longitudinal cross section, defines an inner edge 31 opposite transition internal surface 34. Preferably, inner edge 31 is substantially rectilinear. Inner edge preferably is either parallel to preform longitudinal centerline C or inclined at a positive angle A thereto. A longitudinal line C′ that is parallel to preform centerline C is shown in FIG. 7. Angle A is referred to as a positive angle to indicate that projection lower portion 30 does not form an undercut, but rather is formed to facilitate removal of preform 10 from the mold.

Because projections 26 preferably are disposed in transition portion 14, projections 26 are disposed in a portion of the preform that will likely be stretched and are likely to diminish or disappear during the blowing process. Projections preferably are not disposed on body internal surface 36 where body internal surface forms a right circular cylinder, as a projection in such geometry would cause an undercut that would interfere with removal of preform 10 from the mold during injection molding or like process.

Further, the dashed lines, indicated schematically by reference numeral 11, about preform 10 in FIG. 4 illustrate a mold 11 employed for forming preform 10. Mold 11 forms a cavity that has the attributes of preform 10 described herein. Mold manufacturing for anti-locking features described herein is generally easier and less expensive than for conventional anti-nesting features. The present invention, however, is not limited to molds that are easier and less expensive to manufacture, but rather encompasses any mold configuration subject to the description herein with respect to preform 10.

The description of the embodiment shown in the figures is provided to illustrate an embodiment of the present invention. However, the present invention is not limited to the particular attributes described herein. For example, projections 26 encompass any shapes that can provide point contact with preform 10′. Further, point contact between projections 26 and preform 10′ is not required. Rather, the present invention encompasses any contact between projections 26 and preform 10′. Further, the present invention encompasses any geometry and location of projections 26.

We claim:

1. A preform for forming a blow-molded container, said preform forming a generally tubular shape and comprising a throat, a body, and a transition portion therebetween, the body terminating at an enclosed end portion opposite the throat, a body external diameter being smaller than a throat internal diameter such that the enclosed end portion is insertable into an opening in the throat of an adjacent preform; said preform further comprising:
a body internal diameter being smaller than the throat internal diameter, an internal surface of the transition portion yielding to the throat internal diameter at an upper end and to the body diameter at an opposing lower end thereof;
plural projections disposed on the transition internal surface and extending radially inwardly therefrom, the projections being spaced apart from the throat opening; whereby the projections are configured to contact the adjacent preform during handling to diminish the force required to separate the preform from the adjacent preform upon nesting thereof.

2. The preform of claim 1 wherein said plural projections provide substantially point contact with a body external surface of an adjacent preform.

3. The preform of claim 1 wherein the throat comprises a substantially smooth inner bore.

4. The preform of claim 3 wherein the inner bore of the throat lacks projections.

5. The preform of claim 1 further comprising a circumferential support ring formed on the throat, the projections being disposed entirely below the support ring.

6. The preform of claim 1 wherein the plural projections are three projections spaced circumferentially equidistantly apart.

7. The preform of claim 1 wherein each one of the plural projections, in front elevation view, form a substantially downwardly tapered, rounded shape.

8. The preform of claim 1 wherein the transition portion comprises a substantially frusto-conical inner surface.

9. The preform of claim 8 wherein the throat comprises a substantially cylindrical throat inner surface that couples to the transition inner surface.

10. The preform of claim 5 wherein the body comprises a substantially cylindrical body inner surface that couples to the transition inner surface opposite the throat inner surface.

11. The preform of claim 1 wherein the plural projections have a rounded upper surface and a tapered lower surface.

12. The preform of claim 11 wherein the rounded shape is approximately half of a substantial hemisphere.

13. The preform of claim 11 wherein the projection lower surface, in longitudinal cross section, forms an inner edge that is substantially parallel to a longitudinal centerline of the preform.

14. The preform of claim 13 wherein the projection lower surface does not form an undercut, thereby facilitating removal of the preform upon injection molding.

15. The preform of claim 11 wherein the projection lower surface, in longitudinal cross section, forms an inner edge that defines a positive acute angle with a longitudinal centerline of the preform, thereby enhancing the ease of removal of the preform from an injection mold.

16. The preform of claim 1 wherein the body exterior diameter is less than a finish exterior diameter and a transition portion exterior surface is substantially frusto-conical.

17. The preform of claim 1 wherein the projections contact the enclosed end of the body.

18. The preform of claim 1 wherein the transition inner surface includes non-conical portions.

19. A preform for forming a blow-molded container, said preform comprising a throat and a tapered surface disposed on inside the preform and extending downwardly from the throat, said preform comprising plural projections disposed on the tapered surface, the projections being spaced apart from the throat opening; whereby the projections are configured to contact an adjacent preform during handling to diminish the force required to separate the preform from the adjacent preform upon nesting thereof.

20. The preform of claim 19 wherein said preform has a generally tubular shape comprising a body, the tapered surface being formed on a transition portion between the throat and the body, the body terminating at an enclosed end portion opposite the throat, a body external diameter being smaller than a throat internal diameter such that the enclosed end portion is insertable into an opening in the throat of an adjacent preform.

21. The preform of claim 19 wherein said plural projections provide substantially point contact with a body external surface of an adjacent preform.

22. The preform of claim 21 wherein each one of the plural projections, in front elevation view, form a substantially downwardly tapered, rounded shape.

23. The preform of claim 21 wherein the tapered surface portion comprises a substantially frusto-conical surface.

24. The preform of claim 21 wherein the projection lower surface, in longitudinal cross section, forms an inner edge that is substantially parallel to a longitudinal centerline of the preform.

25. The preform of claim 24 wherein the projection lower surface does not form an undercut, thereby facilitating removal of the preform upon injection molding.

26. The preform of claim 24 wherein the projection lower surface, in longitudinal cross section, forms an inner edge that defines a positive acute angle with a longitudinal centerline of the preform, thereby enhancing the ease of removal of the preform form an injection mold.

27. An injection mold for forming a preform, the injection mold defining a cavity comprising a throat and a tapered surface disposed on inside the preform and extending downwardly from the throat, said preform comprising plural projections disposed on the tapered surface, the projections being spaced apart from the throat opening; whereby the projections are configured to contact an adjacent preform during handling to diminish the force required to separate the preform from the adjacent preform upon nesting thereof.
